(19) United States
(12) Patent Application Publication
(10) Pub. No.: US 2010/0133124 A1
(43) Pub. Date: Jun. 3, 2010

(54) BLISTER TYPE ARTIFICIAL TEETH PACKAGING CONTAINER

(76) Inventors: Hirokazu Satoh, Kyoto (JP); Noriyuki Negoro, Kyoto (JP); Kunihiro Fujii, Kyoto (JP)

Correspondence Address: WENDEROTH, LIND & PONACK, L.L.P., 1030 15th Street, N.W.,, Suite 400 East, Washington, DC, 20005-1503, US

(21) Appl. No.: 12/733,042

(22) PCT Filed: Aug. 8, 2007
(86) PCT No.: PCT/JP2007/065530

§ 371 Date: Feb. 4, 2010

(51) Int. Cl. A61C 19/10

(52) U.S. Cl. 206/83

(57) ABSTRACT

An artificial teeth packaging container 1 including an accommodating member 7 having a plurality of accommodating pockets 10 to 13 in which artificial teeth 2 are inserted from opening portions 14 to 17 and accommodated therein, and a seal member 8 fixed to the accommodating member 7, for sealing the opening portions 14 to 17 of the plurality of pockets 10 to 13 accommodating the artificial teeth 2.

### TECHNICAL FIELD

The present invention relates to an artificial teeth packaging container used for the purpose of conveying and storing the artificial teeth when manufacturing a denture in dental treatment.

### BACKGROUND ART

Existing artificial teeth are disposed on a protuberance formed on a wax rim when manufacturing a denture by using an articulator, and the arrangement is adjusted by matching with a state of occlusion of individual patients. The artificial teeth usually includes twelve artificial teeth corresponding to anterior teeth including right and left central incisors, lateral incisors, and canine teeth, and sixteen artificial teeth corresponding to molar teeth including first premolars, second premolars, first molars, and second molars for the upper jaw and the lower jaw and right and left, respectively. Usually when selling the artificial teeth, six anterior teeth for the upper jaw and the lower jaw, or eight artificial molar teeth for the upper jaw and the lower jaw are arranged in a row, and fixed on a resin-made seat plate by adhesive wax or the like (see, for example, patent document 1 and patent document 2). In order to inform a dentist or a dental technician of necessary information such as a color and a shape of the artificial teeth and manufacturer's name, the seat plate has a display space positioned above or beneath an accommodating portion of the artificial teeth. Patent document 3 discloses a seat plate attached to artificial teeth so that the shape and color may be selected easily.

When fixing the artificial teeth to the seat plate as disclosed in patent documents 1 to 3, usually, wax is used.

However, the wax tends to be adhered easily to the artificial teeth, and this material is softened by temperature rise, and the artificial teeth are likely to drop off from the seat plate of the above-described configuration.

Accordingly, in the above-described seat plate configuration, when conveying or storing the artificial teeth, it was hard to sufficiently prevent loss of the artificial teeth.

Besides, in the manufacturing process of the denture, when removing the artificial teeth from the seat plate of the configuration, the wax is likely to be stuck and left on the cervical portion of the artificial teeth and the periphery thereof. In such a case, an operation for removing the sticking wax is needed, and an extra operation completely different from the arrangement work of artificial teeth was needed. Therefore, as far as the wax is used for fixing the artificial teeth to the seat plate having the configuration, a working efficiency of arrangement cannot be improved basically.
Patent document 1: Japanese Patent Application Laid-Open No. 2000-237213
Patent document 2: Japanese Patent Application Laid-Open No. 2002-315764
Patent document 3: Japanese Patent Application Laid-Open No. 2003-310645

### DISCLOSURE OF THE INVENTION

### Problems to be Solved by the Invention

It is hence an object of the invention to realize an easy package for artificial teeth, by presenting an artificial teeth packaging container capable of preventing loss of the artificial teeth during storing or conveying process, and eliminating extra work indifferent to the arrangement of artificial teeth.

### Means for Solving the Problems

In order to solve the above-mentioned problems, the present invention provides an artificial teeth packaging container including: an accommodating member having a plurality of accommodating pockets in which artificial teeth are inserted from opening portions and accommodated therein, and a seal member fixed to the accommodating member, for sealing the opening portions of the plurality of pockets accommodating the artificial teeth.

Preferably, a plurality of accommodating pockets include the plurality of opening portions mutually separated and formed in the accommodating member, and a plurality of wall portions extended from the plurality of opening portions.

Preferably, the plurality of accommodating pockets include an opening portion formed integrally at one side of the accommodating member, and a wall portion extended from the opening portion, and divided by partition walls.

Preferably, the accommodating member has folding portions for forming groove portions for sliding for sliding and fixing the seal member.

### Effects of the Invention

According to the artificial teeth packaging container of the invention, since the artificial teeth are packaged without using adhesive material such as wax for fixing the artificial teeth, if the temperature changes suddenly in storing or conveying process, the seal member is not separated from the accommodating member, and an accident of loss by separation of artificial teeth during the arrangement work does not occur.

Besides, the invention is free of any operation not related to the arrangement work, such as removal of wax or other adhesive material, and only by removing the artificial teeth from the artificial teeth packaging container of the invention, the artificial teeth can be arranged immediately, and the denture can be manufactured smoothly.

The invention also prevents accidents of storing or conveying of wrong artificial teeth with packaged in a container by mistake.

### BRIEF DESCRIPTION OF THE DRAWINGS

FIG. 1 is a perspective view of an artificial teeth packaging container in an embodiment of the invention, showing a packaged state of the lower-jaw left artificial molar teeth.

FIG. 2 is a sectional view of the artificial teeth packaging container shown in FIG. 1.

FIG. 3 is a sectional view along line of the artificial teeth packaging container shown in FIG. 2.

FIG. 4 is a perspective exploded view of the artificial teeth packaging container shown in FIG. 1.

FIG. 5 is a perspective view of a modified example of the artificial teeth packaging container shown in FIG. 1, showing a packaged state of lower-jaw left artificial molar teeth.

FIG. 6 is a bottom view of the artificial teeth packaging container shown in FIG. 5.

FIG. 7 is a sectional view along line VII-VII of the artificial teeth packaging container shown in FIG. 5.

FIG. 8 is a perspective exploded view of the artificial teeth packaging container shown in FIG. 5.

FIG. 9 is a magnified left side view of a modified example of the accommodating member shown in FIG. 1.

FIG. 10 is a bottom view of the accommodating member shown in FIG. 9.

FIG. 11 is a perspective view showing a method of a use of the accommodating member shown in FIG. 9.

### DESCRIPTION OF REFERENCE NUMERALS

1 Artificial teeth packaging container
2 Lower-jaw left artificial molar teeth
3 Lower-jaw left artificial first premolar tooth
4 Lower-jaw left artificial second premolar tooth
5 Lower-jaw left artificial first molar tooth
6 Lower-jaw left artificial second molar tooth
7 Accommodating member
7a Surface portion of accommodating member
7b Back portion of accommodating member
8 Seal member
9 Accommodating pocket
10 Artificial first premolar tooth accommodating pocket
11 Artificial second premolar tooth accommodating pocket
12 Artificial first molar tooth accommodating pocket
13 Artificial second molar tooth accommodating pocket
14, 15, 16, 17 Opening portion of each accommodating pocket
18, 19, 20, 21 Wall portion of each accommodating pocket
18a, 19a, 20a, 21a Peripheral wall of wall portion of each accommodating pocket
18b, 19b, 20b, 21b Base wall portion of wall of each accommodating pocket
22 Outer peripheral flange of accommodating member
23, 24, 25 Partition portion of accommodating member
26 Opening portion of accommodating pocket
27 Outer peripheral wall of accommodating pocket
27a Peripheral wall of outer peripheral wall of accommodating pocket
27b Base wall of outer peripheral wall of accommodating pocket
28 First partition wall
29 Second partition wall
30 Third partition wall
31 First folding portion
32 Second folding portion
33 Third folding portion
34 Groove portion for sliding
35 Groove portion for stopper

### BEST MODE FOR CARRYING OUT THE INVENTION

The invention is described below while referring to the accompanying drawings.

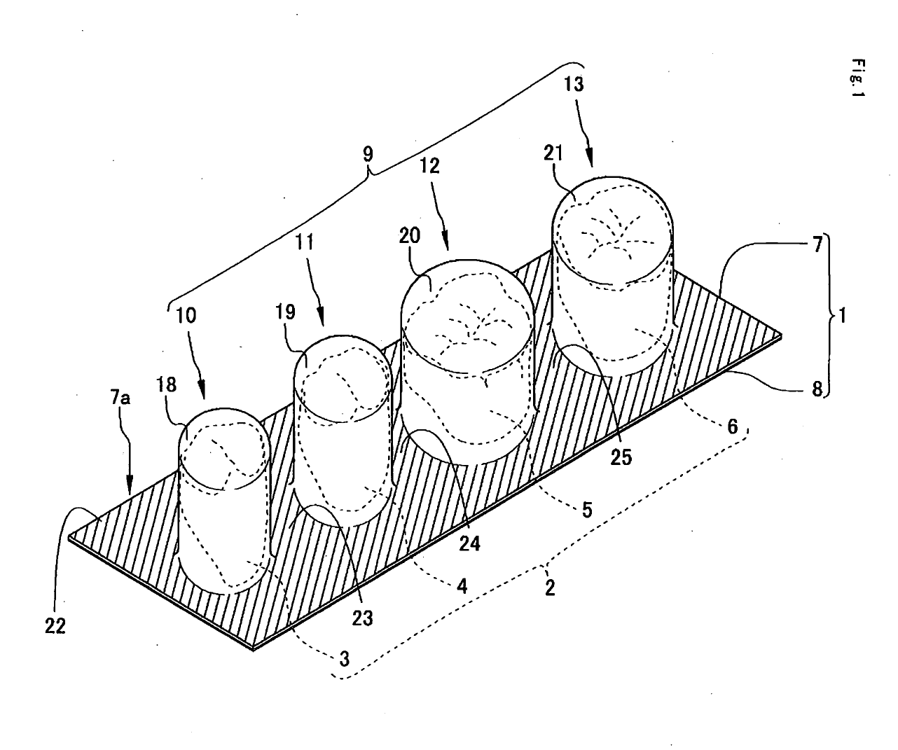

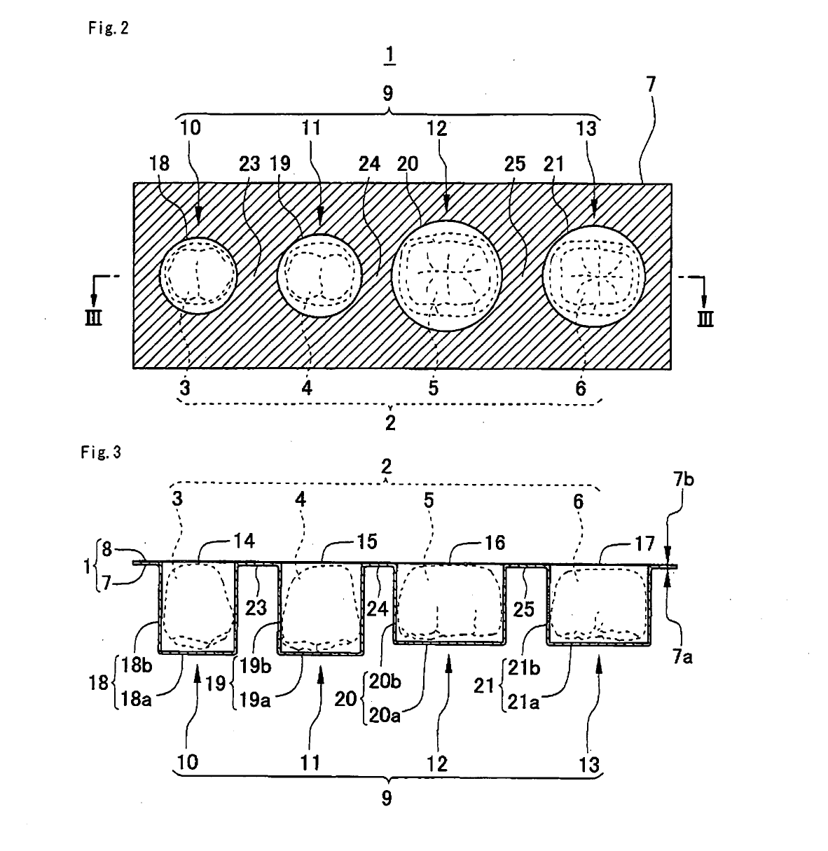

FIG. 1 to FIG. 4 show an artificial teeth packaging container 1 according to a preferred embodiment of the invention for packaging artificial teeth. Herein, the “artificial teeth” refer to teeth of existing products used when manufacturing a denture as an artificial human organ, and various types and shapes are available depending on the variety, color, and form, and when the artificial teeth are classified roughly, ceramic teeth made of porcelain materials and resin teeth made of resin materials are used. The artificial teeth are usually sold individually as each set of six upper artificial anterior teeth, six lower artificial anterior teeth, eight upper artificial molar teeth, and eight lower artificial molar teeth.

The artificial teeth packaging container 1 is designed to package a plurality of artificial teeth in an arbitrary combination, and as shown in FIG. 1 to FIG. 4, in the embodiment, an example is explained about packaging of four lower-jaw left artificial molar teeth 2 including a lower-jaw left artificial first premolar tooth 3, a lower-jaw left artificial second premolar tooth 4, a lower-jaw left artificial first molar tooth 5, a lower-jaw left artificial second molar tooth 6. The artificial teeth packaging container 1 includes an accommodating member 7 for accommodating the lower-jaw left artificial molar teeth 2, and a seal member 8 adhered to the accommodating member 7 accommodating the lower-jaw left artificial molar teeth 2.

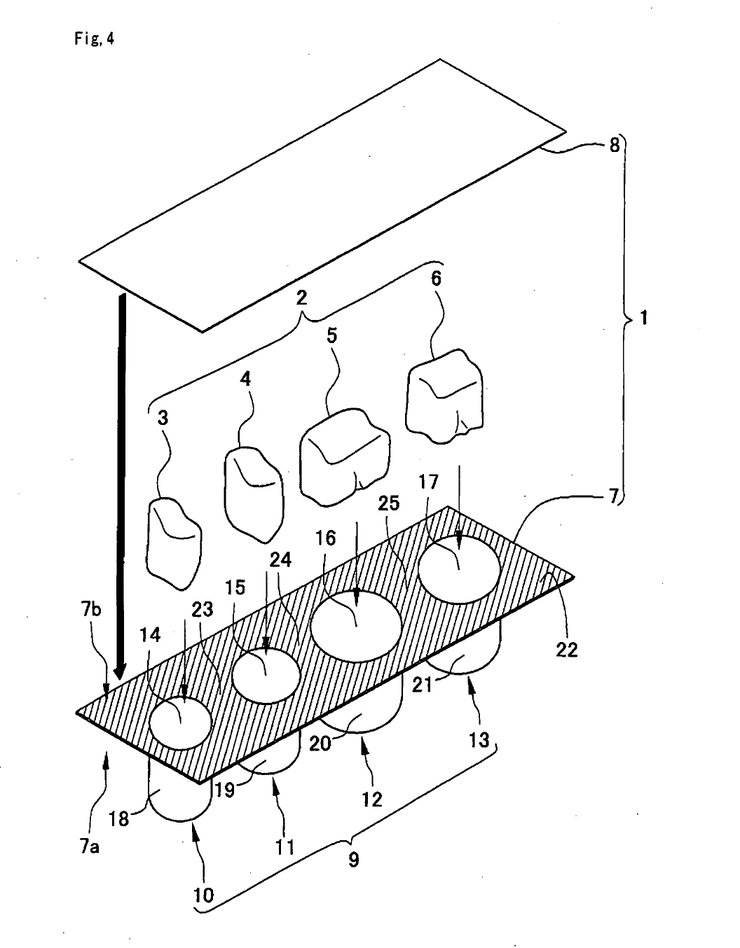

The accommodating member 7 includes a substantially square transparent synthetic resin sheet or photo-curing resin sheet, and has an accommodating pocket 9. One side of the synthetic resin sheet or the like forms a surface portion 7a of the accommodating member 7 as shown in FIG. 3, and the other side forms a back portion 7b of the accommodating portion 7.

The accommodating pocket 9 includes an artificial first premolar tooth accommodating pocket 10 for accommodating a lower-jaw left artificial first premolar tooth 3, an artificial second premolar tooth accommodating pocket 11 for accommodating a lower-jaw left artificial second premolar tooth 4, an artificial first molar tooth accommodating pocket 12 for accommodating a lower-jaw left artificial first molar tooth 5, and an artificial second molar tooth accommodating pocket 13 for accommodating a lower-jaw left artificial second molar tooth 6. The accommodating member 7 is formed of the synthetic resin sheet or the like by any known method such as press forming, blow forming, injection forming, or photo molding, and in the embodiment, as shown in FIG. 3, the accommodating pockets 10 to 13 are formed in concave shape.

The accommodating pockets 10 to 13, as shown in FIG. 3, include opening portions 14, 15, 16, 17 in which the lower-jaw left artificial molar teeth 3 to 6 are inserted, and wall portions 18, 19, 20, 21 extended from these opening portions 14, 15, 16, 17 toward the surface portion 7a side of the accommodating member 7. The opening portions 14 to 17 of the accommodating pockets 10 to 13 are formed in a circular shape as shown in FIG. 4, and are formed mutually apart from the back portion 7b side of the accommodating member 7. The wall portions 18 to 21 of the accommodating pockets 10 to 13, as shown in FIG. 3, include peripheral walls 18a, 19a, 20a, 21a continuously arranged to the opening portions 14 to 17, and base walls 18b, 19b, 20b, 21b continuously arranged to these peripheral walls 18a to 21a.

In the embodiment, the accommodating pocket 9 is arranged in a row in the sequence of the artificial first premolar tooth accommodating pocket 10, the artificial second premolar tooth accommodating pocket 11, the artificial first molar tooth accommodating pocket 12, the artificial first molar tooth accommodating pocket 13, and the artificial second molar tooth accommodating pocket 13. The individual accommodating pockets 10 to 13 are formed in a shape corresponding to the size and shape of the individual lower-jaw left artificial molar teeth 3 to 6, and the artificial first premolar tooth accommodating pocket 10 and the artificial second premolar tooth accommodating pocket 11 have the opening portions 10a, 11a formed in a smaller size than the artificial first molar tooth accommodating pocket 12 and the artificial second molar tooth accommodating pocket 13.

The accommodating member 7 includes an outer peripheral flange 22 formed around the accommodating pocket 9, and partition portions 23, 24, 25 formed between the opening portions 14 to 17 of the accommodating pockets 10 to 13. The back portion 7b of the accommodating member 7 has a fusion region defined by the outer peripheral flange 22 and the partition portions 23, 24, 25. The opening portions 14 to 17 of the accommodating pockets 10 to 13 are sealed by a seal member 8 when the seal member 8 is heated, fused and fixed in the fusion region of the accommodating member 7 with the lower-jaw left artificial molar teeth 2 being accommodated in the accommodating pocket 9.

The synthetic resin sheet used in forming of the accommodating member 7 includes a transparent sheet of 0.01 mm to 0.05 mm in thickness made of, for example, polyvinyl chloride (PVC), polystyrene (PS), polyethylene terephthalate (PET), polypropylene (PP), or amorphous polyethylene terephthalate (A-PET).

The seal member 8 is a tearable square sheet of aluminum foil, paper, or plastic film of 0.01 mm to 0.05 mm in thickness, and in the embodiment, it is formed in a size same as an outer peripheral dimension of the accommodating member 7. The seal member 8 seals, as shown in FIG. 4, the opening portions 14 to 17 of the accommodating pockets 10 to 13 in a state where the lower-jaw left artificial molar teeth 3 to 6 are fixed to the fusion region of the accommodating member 7 by heat fusion or the like with accommodated in the accommodating pockets 10 to 13.

For example, when taking out the lower-jaw left artificial first premolar tooth 3 from the artificial teeth packaging container 1 of the embodiment upon manufacturing the denture, the base wall 18b of the wall portion 18 of the artificial first premolar tooth accommodating pocket 10 is projected toward the back portion 7b side of the accommodating member 7, and the seal member 8 is torn by the projected lower-jaw left artificial first premolar tooth 3. As a result, the periphery of the cervical portion of the lower-jaw left artificial first premolar tooth 3 is exposed from the seal member 8, and this exposed portion is held and the lower-jaw left artificial first premolar tooth 3 is pulled out from the artificial first premolar tooth accommodating pocket 10, or the base wall 18b of the wall portion 18 of the artificial first premolar tooth accommodating pocket 10 is further pushed toward the back portion 7b side of the accommodating member 7, and the lower-jaw left artificial first premolar tooth 3 is separated from the artificial first premolar tooth accommodating pocket 10. The other artificial molar teeth 4 to 6 can be also taken out of the accommodating pockets 11 to 13 in the same procedure. The lower-jaw left artificial molar teeth 2 taken out of the artificial teeth packaging container 1 of the embodiment are buried into protuberances of the wax rim of a mandible model attached to an articulator spuriously mimicking the motion of human jaw, and arranged by using the articulator while adjusting the arrangement positional relation with the adjacent artificial teeth and arrangement positional relation with the upper left artificial molar teeth positioned above. The lower-jaw left artificial molar teeth 2, after completing the arrangement, are coated with wax or the like in the cervical portion, and fixed to the wax rim of the mandible model.

When packaging the artificial teeth by the artificial teeth packaging container 1 of the embodiment, only the artificial teeth are accommodated in the accommodating pocket 9 of the accommodating member 7, and the accommodating member 7 and the seal member 8 are heat-fused, and the opening portions 14 to 17 are sealed, and therefore when packaging the artificial teeth, it is not needed to coat the artificial teeth with adhesive material such as wax for fixing artificial teeth. The heat fusion of the packaging member 7 and the seal member 8 is hardly influenced by temperature changes, and if the temperature changes suddenly in the storing or conveying process, the seal member 8 is not separated from the accommodating member 7, and the artificial teeth are not separated and lost before the arrangement work.

Besides, the packaging material using wax or other adhesive material requires an extra operation completely indifferent from the arrangement of artificial teeth such as removal of adhesive material remaining on the artificial teeth, but in the case of the artificial teeth packaging container 1 of the embodiment, such removal work of adhesive material is not needed, and only by taking out the artificial teeth from the accommodating pocket 9, the artificial teeth can be arranged immediately, and the denture can be manufactured smoothly.

In the artificial teeth packaging container 1 of the embodiment, the accommodating pocket 9 is formed in a shape and a size corresponding to the artificial teeth to be accommodated. Hence, if the artificial teeth are larger than expected, they cannot be accommodated within the accommodating pocket 9. On the other hand, if the artificial teeth are smaller than expected, they can be accommodated within the accommodating pocket 9, but it can be seen visually that wrong artificial teeth are put therein if the accommodating pocket 9 is observed before sealing the seal member 8. As a result, it is possible to prevent wrong artificial teeth from being accommodated the accommodating pocket 9.

The artificial teeth packaging container 1 of the embodiment is merely an example for explaining the invention, and its configuration is not limited to the embodiment described above, and may be modified, for example, as shown below.

First, the accommodating member 7 of the artificial teeth packaging container 1 is not particularly specified as far as a plurality of artificial teeth can be combined arbitrarily and accommodated in the accommodating pocket 9, and, for example, right or left side of four lower-jaw right artificial molar teeth or four upper artificial molar teeth, a total of fourteen artificial teeth for the upper jaw or lower jaw, or two, four or six artificial anterior teeth for the upper jaw or lower jaw may be combined as artificial teeth to be accommodated in the artificial teeth accommodating member 7, and the combined artificial teeth may be accommodated in the accommodating pocket 9, and sealed with the seal member 8. The artificial teeth to be accommodated in the accommodating member 7 are not limited to these artificial molar teeth or artificial anterior teeth, but may include shell members to be adhered to the surface of thinly ground teeth to be enhanced in an aesthetic appearance of teeth, or connection teeth formed by mutually connecting the artificial molar teeth or artificial anterior teeth.

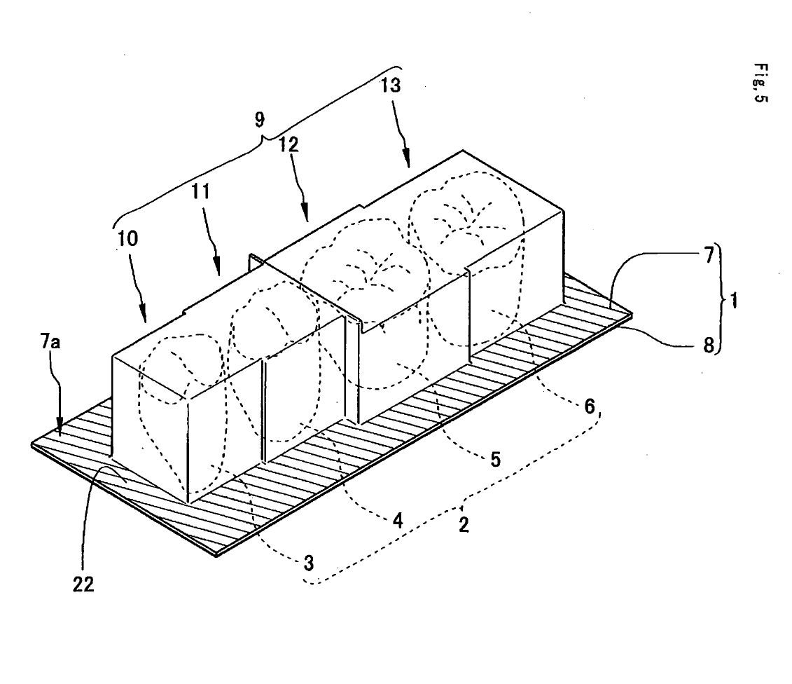

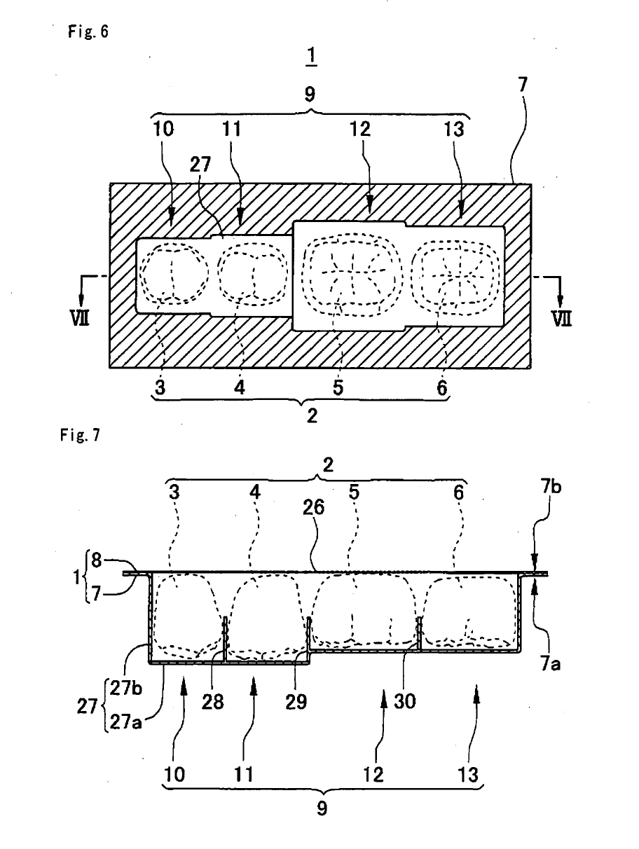

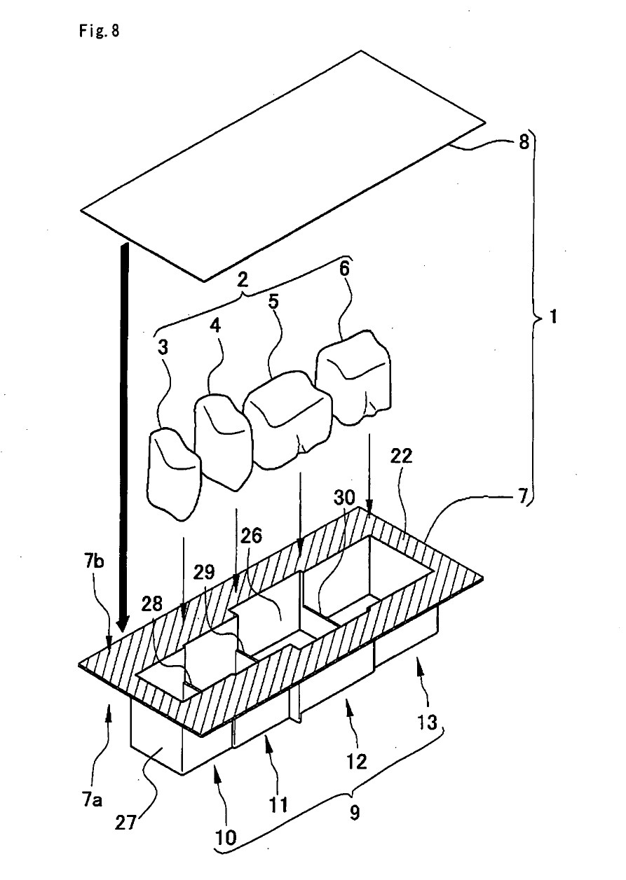

In the embodiment, the opening portions 14 to 16 of the accommodating pockets 10 to 13 for inserting the lower-jaw left artificial molar teeth 3 to 6 are formed by separating from each other at the back portion 7b side of the accommodating member 7, and a plurality of wall portions 18 to 21 are extended from the opening portions 14 to 16 toward the surface portion 7a side of the accommodating member 7, but as shown in FIG. 5, for example, opening portions 26 of accommodating pockets 10 to 13 for inserting the lower-jaw left artificial molar teeth 3 to 6 are formed integrally, and the accommodating pocket 9 may be formed so that one outer peripheral wall 27 including a peripheral wall 27a and a base wall 27b may be extended from this opening portion 26 toward the surface portion 7a side of the accommodating member 7. In this way, when the opening portion 26 is formed integrally, depending on the number of artificial teeth to be accommodated, partition walls are set perpendicularly on the base wall 27b of the outer peripheral wall 27, and a space defined by the outer peripheral wall 27 is divided into a plurality of sections, and thereby the accommodating pocket 9 may be formed. In the artificial teeth packaging container 1 shown in FIG. 5 to FIG. 8, a first partition wall 28, a second partition wall 29, and a third partition wall 30 are installed perpendicularly on the inner side of the base wall 27b of the outer peripheral wall 27, and the space defined by the outer peripheral wall 27 is divided into four sections, and the accommodating pocket 9 including artificial first premolar tooth accommodating pocket 10, artificial second premolar tooth accommodating pocket 11, artificial first molar tooth accommodating pocket 12, and artificial second molar tooth accommodating pocket 13 is formed, and the lower-jaw left artificial molar teeth 3 to 6 are accommodated in the individual accommodating pockets 10 to 13.

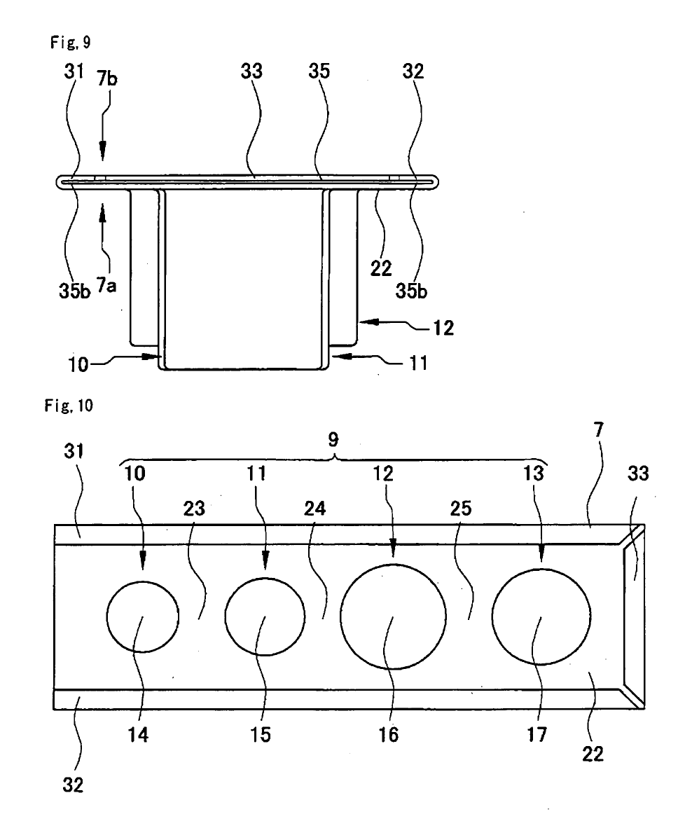

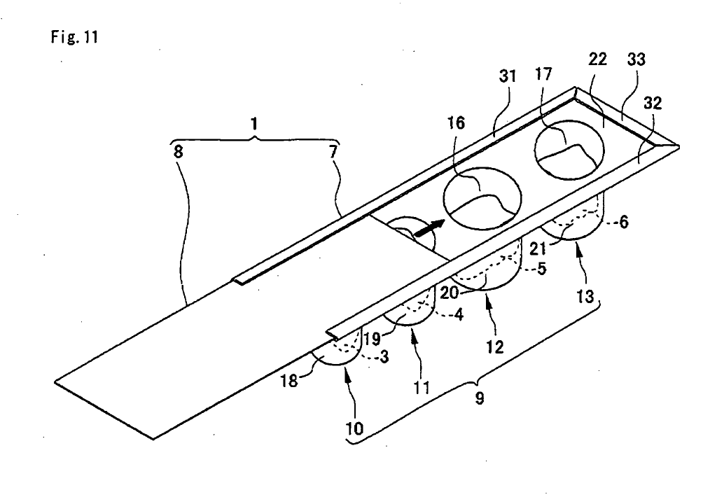

Further, fixing means of the seal member 8 to the accommodating member 7 is not limited to heat fusion, but as shown in FIG. 9, for example, folding portions 31, 32, 33 folded to the back portion 7b side are provided at an end portion of the accommodating member 7, and a sliding groove portion 34 for sliding the seal member 8 and a stopper groove portion 35 for limiting the sliding of the seal member 8 may be formed. In the accommodating member 7 shown in FIG. 9 to FIG. 11, the first and second folding portions 31, 32 are provided at both ends of a longer side, and the sliding groove portion 32 (?34) is formed. The third forming portion 33 is provided at one end of a shorter side of the second molar tooth accommodating pocket 13 side, and the stopper groove portion 35 is formed. Since the seal member 8 is not required to be torn, it may be formed of a square sheet such as paper or plastic material that is thicker than that in the above embodiment.

The accommodating pockets 10 to 13 of the accommodating member 7 are not limited to the shown shape, but the accommodating pockets 10 to 13 may be formed in any shape suited to the shape of the artificial teeth to be accommodated, and they may be desired to prevent accommodation of wrong artificial teeth by mistake. In the embodiment, cutting lines may be formed between the seal member 8 and the accommodating pockets 10 to 13 of the accommodating member 7, so that the accommodating pockets 10 to 13 may be separated individually in the unit package form of the artificial teeth packaging container 1. Alternatively, cutting lines for tearing or thin portions for tearing may be formed in the sealing region of the seal member 8 corresponding to the opening portions 14 to 17 of the accommodating pocket 9, and when taking out the artificial teeth, the seal member 8 may be torn easily. Further, in order to form a picking portion for separating, the accommodating member 7 and the seal member 8 may be adhered without adhering one of the corners.

1. An artificial teeth packaging container comprising:
an accommodating member having a plurality of accommodating pockets in which artificial teeth are inserted from opening portions and accommodated therein, and
a seal member fixed to the accommodating member, for sealing the opening portions of the plurality of pockets accommodating the artificial teeth.

2. The artificial teeth packaging container of claim 1, wherein the plurality of accommodating pockets include a plurality of wall portions including a plurality of opening portions mutually separated and formed in the accommodating member, peripheral walls continuously arranged to the plurality of opening portions, and base walls contacting with the peripheral walls.

3. The artificial teeth packaging container of claim 1, wherein the plurality of accommodating pockets include an opening portion formed integrally at one side of the accommodating member, an outer peripheral wall including a peripheral wall continuously arranged to the opening portion and a base wall continuously arranged the peripheral wall, and a partition wall provided perpendicularly on the base wall of the outer peripheral wall for dividing a space defined by the outer peripheral wall into a plurality of sections.

4. The artificial teeth packaging container of claim 1, wherein the accommodating member has folding portions for forming a sliding groove portion for sliding the seal member, and a fixing groove portion for limiting a sliding motion of the seal member.

5. The artificial teeth packaging container of claim 2, wherein the accommodating member has folding portions for forming a sliding groove portion for sliding the seal member, and a fixing groove portion for limiting a sliding motion of the seal member.

6. The artificial teeth packaging container of claim 2, wherein the accommodating member has folding portions for forming a sliding groove portion for sliding the seal member, and a fixing groove portion for limiting a sliding motion of the seal member.
